(19) United States
(12) Patent Application Publication
(10) Pub. No.: US 2020/0376389 A1
(43) Pub. Date: Dec. 3, 2020

(54) METHODS OF MATCHMAKING BASED ON DYNAMIC MATCHMAKING PARAMETERS

(71) Applicant: Arachnid 360, LLC, Loves Park, IL (US)

(72) Inventor: Patrick G. RICE, Brodhead, WI (US)

(21) Appl. No.: 16/886,605

(22) Filed: May 28, 2020

Related U.S. Application Data
(60) Provisional application No. 62/854,829, filed on May 30, 2019.

(51) Int. Cl. A63F 13/795; A63F 13/798; G06K 9/62

(52) U.S. Cl. CPC A63F 13/795; A63F 2300/5593; G06K 9/6215; A63F 13/798

(57) ABSTRACT

The present inventive concept contemplates a method of linking remote players in competitive play by retrieving skill metrics of a player and determining whether the skill metrics of the player rises above a minimum skill threshold for a competitive event. Responsive to determining that the skill metrics of potential player rises above the minimum skill threshold for the competitive event, the method contemplates sending the potential player a communication, such as an invitation to the competitive event and/or a promotional communication.

This application claims the benefit of priority to U.S. Provisional Patent Application Ser. No. 62/854,849, filed May 30, 2019, which is incorporated herein by reference in its entirety.

### FIELD OF THE INVENTION

The field of the invention is software-based matchmaking.

### BACKGROUND

The present invention enables matchmaking between any combinations of players based on one or more parameters. Especially in competitive sports that can and often are played in the home or in small local venues, there are less formal pipelines for discovering and developing potential professional talent.

Systems and methods for feeding talent into competitive, professional, and/or official tournaments are known in the field of conventional sports. For example, conventional sports like tennis, football, soccer, and baseball all use well-known scouting tactics and data tracking through official games to determine which players should be encouraged to pursue greater opportunities in their sport. One key factor in the success of conventional scouting tactics is the fact that conventional sports are tied to particular venues where players must gather together to publicly compete. As such, opportunities to observe and track players are much more abundant.

However, the proliferation of highly competitive activities that occur in the privacy of a home has made traditional methods of recruitment, scouting, and outreach insufficient to bring in highly skilled players. For example, the explosion of electronic sports (“e-sports”) has caused an activity that occurs normally within the privacy of one's home to be broadcasted publically in huge tournaments with significant prize money. In another example, sports, such as electronic darts, can be played remotely and enjoyed competitively without ever visiting a public venue to play. As such, significant challenges exist in recruiting highly skilled players from these commonly private competitive activities to participate in public or semi-public events. Semi-public events can include, for example, private spaces that are legally considered public establishments.

US Patent Application Publication No. 2012/0149472 to Miller teaches methods for scouting potential talent from professional sports players for a participant's fantasy sports line up. Miller does not teach the recruiting of actual players, including both professional and amateur players, to participate in remote competitions and/or local competitions.

US Patent Application Publication No. 2013/0165238 to Jerez teaches a method of creating activities with custom rules to compete with other remote players. Jerez fails to teach the networking of amateur players and/or professional players to identify a talent pool and using that talent pool to recruit and encourage skilled players to participate in official tournaments and events.

Miller, Jerez, and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for matchmaking systems that assist in the recruitment and outreach of skilled players in remote play-based competitive activities.

### SUMMARY OF THE INVENTION

The inventive concept herein contemplates a matchmaking method that identifies and feeds talent into organized matches by, in part, recording and retrieving performance data of a pool of players and matching players against each other based on their performance data.

After receiving a requisite amount of performance data from one or more matches, the inventive concept contemplates determining whether a player meets a skill threshold. The skill threshold does not necessarily include only professional events, but any organized event and/or competition. In contrast to conventional matchmaking technologies, the present invention advantageously allows for broad outreach and direct communication to players to encourage participation in public events.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a functional block diagram illustrating a distributed data processing environment.

FIG. 2 is a schematic of a method of executing a matchmaking system and recording performance data for player associated with a match.

FIG. 3 is a schematic of a method of determining whether the first player meets a competitive threshold and offering opportunities for the first player to compete through official channels.

FIG. 4 depicts a block diagram of components of the server computer executing the matchmaking engine within the distributed data processing environment of FIG. 1.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including allowing users to create personalized remote competitive environments for others to access.

As disclosed herein, “types of events” and any derivatives of these terms can be associated with a specific event and categories of events. Types of events can be associated with levels of abstraction. For example, types of events can refer to the specific sport of basketball. In another example, types of events can refer to an overarching genre of physical sports.

As disclosed herein, “similar events” refer to any events that are within a shared category. For example, similar events to basketball games can include baseball games, soccer games, and football games.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

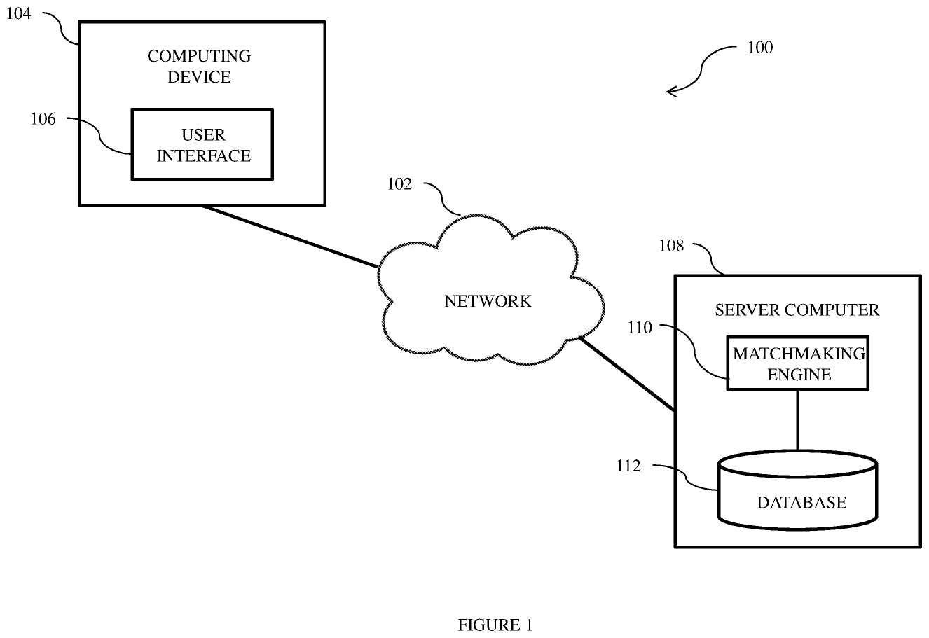

FIG. 1 is a functional block diagram illustrating a distributed data processing environment.

The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 104 and server computer 108, interconnected over network 102. Network 102 can include, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between computing device 104, server computer 108, and any other computing devices (not shown) within distributed data processing environment 100.

It is contemplated that computing device 104 can be any programmable electronic computing device capable of communicating with various components and devices within distributed data processing environment 100, via network 102. It is further contemplated that computing device 104 can execute machine readable program instructions and communicate with any devices capable of communication wirelessly and/or through a wired connection. Computing device 104 includes an instance of user interface 106.

User interface 106 provides a user interface to matchmaking engine 110. Preferably, user interface 106 comprises a graphical user interface (GUI) or a web user interface (WUI) that can display one or more of text, documents, web browser windows, user option, application interfaces, and operational instructions. It is also contemplated that user interface can include information, such as, for example, graphics, texts, and sounds that a program presents to a user and the control sequences that allow a user to control a program.

In some embodiments, user interface can be mobile application software. Mobile application software, or an “app,” is a computer program designed to run on smart phones, tablet computers, and any other mobile devices.

User interface 106 can allow a user to register with and configure matchmaking engine 110 (discussed in more detail below) to enable artificial intelligence engine to find and predict patterns of user behavior. It is contemplated that user interface 106 can allow a user to provide any information to matchmaking engine 110. In one embodiment, user interface 106 can receive authentication information from a user including, for example, a user id and password. Authentication can also be achieved by any one or more sensors including biometric sensors, such as fingerprint readers and facial recognition technologies.

User interface 106 can include an instance of an app remotely connected to matchmaking engine 110. It is contemplated that the app can connect larger communities of players and includes social media functionality. For example, an electronic darts player can communicate with other electronic dart players in the area and exchange media via the app.

Server computer 108 can be a standalone computing device, a management server, a web server, a mobile computing device, or any other computing system capable of receiving, sending, and processing data.

It is contemplated that server computer 108 can include a server computing system that utilizes multiple computers as a server system, such as, for example, a cloud computing system.

In other embodiments, server computer 108 can be a computer system utilizing clustered computers and components that act as a single pool of seamless resources when accessed within distributed data processing environment 100.

Database 112 is a repository for data used by matchmaking engine 110. In the depicted embodiment, matchmaking engine 110 resides on server computer 108. However, database 112 can reside anywhere within a distributed data processing environment provided that matchmaking engine 110 has access to database 112.

Data storage can be implemented with any type of data storage device capable of storing data and configuration files that can be accessed and utilized by server computer 108. Data storage devices can include, but are not limited to, database servers, hard disk drives, flash memory, and any combination thereof.

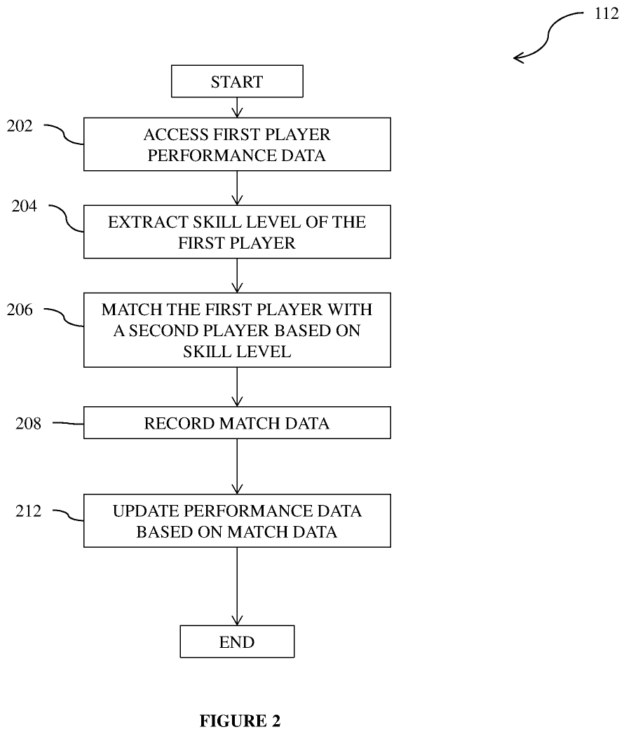

FIG. 2 is a schematic of a method of executing a matchmaking system and recording performance data for player associated with a match.

Matchmaking engine 110 accesses performance data of a first player (step 202).

Matchmaking engine 110 can access the performance data of the first player in any manner and by any means known in the art.

In one embodiment, matchmaking engine 110 accesses one or more databases through network 102 to retrieve player data. Player data can include, but is not limited to, player identification information and associated player statistics. For example, matchmaking engine 110 can access remote servers through a cloud-based data infrastructure to retrieve performance data that is updated in substantially real-time. In another example, matchmaking engine 110 can retrieve performance data of other players to present to the first player for comparison.

In another embodiment, matchmaking engine 110 can access and manipulate data associated with one or more players. For example, matchmaking engine 110 can update one or more databases with current player statistics that are stored on an in-home electronic dartboard on a real-time basis. In another example, matchmaking engine 110 can create a new player profile for players without any existing performance data.

It is further contemplated that matchmaking engine 110 can cooperate with multiple devices. For example, matchmaking engine 110 can executed via a smart phone application coupled to an electronic dartboard to update, share, and retrieve data by proxy of a smart phone.

Matchmaking engine 110 extracts a skill level of the first player (step 204).

It is contemplated that matchmaking engine 110 can employ any means known in the art to extract a skill level of the player. In some embodiment, matchmaking engine 110 can apply one or more algorithms to determine a skill level from the performance data of a player. For example, matchmaking engine 110 can use an algorithm that weighs a variety of statistics associated with a player to produce a composite score, which is then used to determine a skill level of the player.

In another example, matchmaking engine 110 can use machine learning algorithms to make predictions about the skill level of a player based on a limited pool of data. In a more specific example, matchmaking engine 110 can user a chronological predictive model, which uses historical performance data of a player to predict the future performance in a competitive match. Various examples of machine learning algorithms that can be used by matchmaking engine 110 are described in further detail below.

Using a descriptive analytical framework, matchmaking engine 110 can analyze the data to quantitatively describe the main trends in a collection of data.

Using an exploratory analytical framework, matchmaking engine 110 can analyze data sets to find previously unknown relationships. For example, matchmaking engine 110 can use one or more algorithms, including, for example, machine learning algorithms such as time-series forecasting, supervised learning classifiers, and linear regression analyses, to determine a connection between two seemingly unrelated user data points (e.g., finding a connection between a professional level player performance when teamed up with other players with particular play styles).

Using an inferential analytical framework, matchmaking engine 110 can analyze a representative subgroup of data sets to make inferences about a bigger population. For example, matchmaking engine 110 can analyze a data set representing the active dart players in Britain, and determine that a player from that region is most likely to accept invitations to compete in a particular type of dart game.

Using a predictive analytical framework, matchmaking engine 110 can analyze current and historical data to make predictions about future events. Predictive analytical frameworks can include the use of supervised learning classifiers, time-series forecasting, and any other machine-learning algorithms.

It is contemplated that using supervised learning classifiers allows matchmaking engine 110 to make inferences from the data based on what is taught by the training data in order to analyze unexpected situations in a more reasonable way (e.g., come to conclusions that a human being might come to). Training data can include data that is collected by matchmaking engine 110 and data that is directly inputted by a user.

In another example, matchmaking engine 110 can use time-series forecasting to predict the variations in player performance based on the time-based variables. For example, matchmaking engine 110 can determine that a player is more likely to compete at a competitive level during summer months, when the weather is warmer. In another example, matchmaking engine 110 can determine that a player is more likely to compete in tournaments during the winter months for an online competitive multiplayer game, when there is less incentive to engage in outdoor activities.

Using a causal analytical framework, matchmaking engine 110 can adjust one variable in a real or hypothetical situation to determine how it affects another variable. For example, matchmaking engine 110 can analyze a player's historical match participation data and determine how a reduction in prize money for a competition will likely affect a players participation in the competition.

Further, the specific manner in which matchmaking engine 110 extracts the skill level of the first player can vary depending on one or more objectives. For example, matchmaking engine 110 can extract the skill level of a first player in multiple categories associated with darts, such as consistency, accuracy, and player stats in derivative types of dart games (e.g. cricket, dart golf, etc.).

In another example, matchmaking engine 110 can extract statistics recorded on public databases to extract the skill level of the first player in an online video game. In a more specific example, matchmaking engine 110 can extract the player level, competitive match win/loss ratio, most effective character, and any other relevant statistics associated with the first player in a cooperative online video game.

In an alternative embodiment, matchmaking engine 110 can disregard the skill level of a player. For example, matchmaking engine 110 can ignore skill levels in a casual play environment where any one or more players can play with another one or more players, such as in friend-based matchmaking.

Matchmaking engine 110 matches the first player with a second player based on the first player's skill level (step 206).

Matchmaking engine 110 is not limited to matching two players at a time and can also match multiple players against each other in any configuration. For example, matchmaking engine 110 can match the first player with a second player in a bracket comprising a large number of competitors vying for the top spot. In another example, matchmaking engine 110 can match a team of players comprising the first player against a second team of players.

In one embodiment, matchmaking engine 110 matches the first player with the second player based on an objective. For example, matchmaking engine 110 can match the first player with a second player with performance data that is at a slightly higher level to gauge skill progression. In another example, matchmaking engine 110 can match the first player with a second player who plays with a more challenging play style for the first player.

Matchmaking engine 110 records match data (step 208).

Matchmaking engine 110 can record match data in any manner known in the art.

In one embodiment, matchmaking engine 110 records match data in substantially real-time. For example, the results of a competitive dart match between the first player and the second player can be recorded in a database and made accessible through network 102 to anyone with an internet connection.

In another embodiment, matchmaking engine 110 records match data on an intermittent basis. For example, matchmaking engine 110 can record match data based on temporal considerations, such as recording all match data at the end of every day. In another example, matchmaking engine 110 can record match data based on achieving one or more objectives, such as recording the overall winner of a competitive dart bracket once the final winner is determined.

In an alternative embodiment, matchmaking engine 110 disregards match data. For example, matchmaking engine 110 can disregard match data in a casual play environment where statistics are not recorded.

Matchmaking engine 110 updates the first player performance data and the second player performance data based on the match data (step 210).

Matchmaking engine 110 can update player performance data in any one or more databases associate with matchmaking engine 110. In preferred embodiments, matchmaking engine updates one or more databases through network 102, such that the player performance data is accessible over the internet.

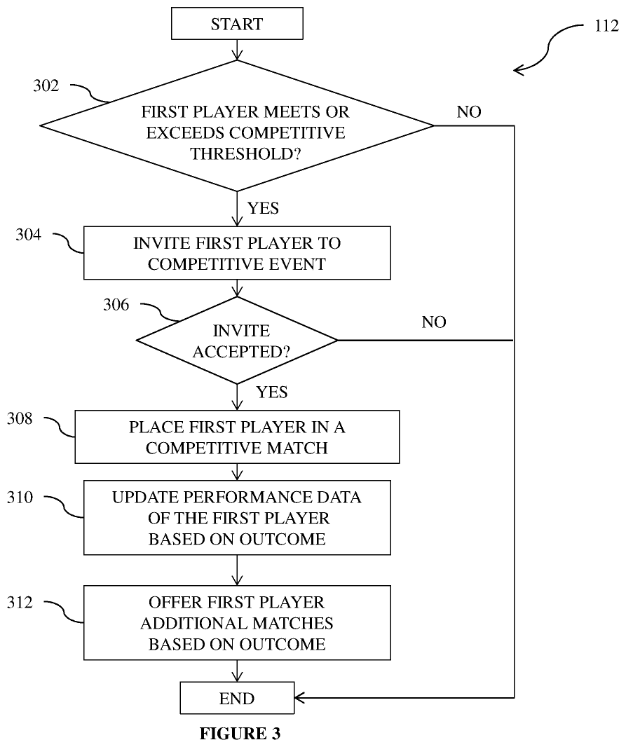

FIG. 3 is a schematic of a method of determining whether the first player meets a competitive threshold and offering opportunities for the first player to compete through official channels.

Matchmaking engine 110 determines whether the first player meets or exceeds a competitive threshold (decision block 302).

In one embodiment, the competitive threshold is predetermined. For example, matchmaking engine 110 can determine whether the first player exceeds a competitive threshold defined as being above a specific win/loss ratio against players of a particular skill level. In another example, matchmaking engine 110 can determine whether the first player meets or exceeds a predetermined minimum score per game.

However, it is also contemplated that the competitive threshold can be determined via machine learning techniques, and can be determined at any point at which matchmaking engine 110 can identify a pattern in the data. Based on the data patterns associated with a player's performance data, matchmaking engine 110 can determine whether the player meets or exceeds a competitive threshold.

In some embodiments, matchmaking engine 110 determines whether an amount of collected performance data is sufficient to satisfy the machine learning threshold prior to determining whether a player meets of exceed a competitive threshold. For example, matchmaking engine 110 can, at the end of a second week of collecting player performance data, identify that the user is highly inconsistent in performance. In another example, matchmaking engine 110 can determine whether the amount of collected performance data is sufficient based on whether the amount of collected data is sufficient to predict user match outcomes above a minimum threshold, for example, a confidence interval above 70%.

In another embodiment, matchmaking engine 110 determines whether the amount of collected performance data is sufficient to satisfy the machine learning threshold based on a preset threshold by a third party. For example, matchmaking engine 110 can determine that the amount and type of data collected satisfies requirements set for by an administrator requiring at least 1000 collected data points prior to applying machine learning and a maximum lapse of three days between each data point.

Responsive to determining that the first player does not meet or exceed the competitive threshold (“NO” branch, decision block 302), matchmaking engine 110 ends.

Responsive to determining that the first player meets or exceeds the competitive threshold (“YES” branch, decision block 302), matchmaking engine 110 invites the first player to a competitive event (step 304).

It is contemplated that the competitive event can be any combination of organized and unorganized matches. In one embodiment, the competitive event is a purely organized match. For example, the competitive event can be an official league sponsored event with a mixture of professional and amateur players competing for a top prize. In another example, an electronic darts player can play 20 matches within a designated time period for an official online event and their best scores can be used to determine where the electronic darts player ranks in the event.

In another embodiment, the competitive event includes unorganized matches. For example, a player in an online strategy game may have to exceed a win/loss ratio for the most recent 50 matches to qualify for an official competition.

In one embodiment, the competitive event takes place between remote user devices 106. For example, electronic dartboards remotely connected over network 102 can participate in a series of competitive rounds to qualify for an in-person dart competition. In another example, multiple devices remotely connected over network 102 can compete in an online first-person shooter and each player's statistics can be updated on one or more databases 112.

In yet another embodiment, the competitive event can be any privately held match between at least two parties. For example, the competitive event can include a first remote player and a second remote player who have chosen to play a competitive match over the internet.

In another example, the competitive event can be a private match with a mixture of local and remote players. In a more specific example, two teams of players can be located in two respective remote locations.

It is contemplated that competitive matches may require player identity verification. The present invention contemplates identifying players in any manner available in the art. For example, matchmaking engine 110 can require authentication measures, such as match specific passwords, to be inputted before allowing a player into a match. In another example, matchmaking engine 110 can use any one or more sensors to verify the identity of the players. For example, voice recognition technologies can be used to verify player identities. In another example, optical sensors can capture the visual appearance of a user and software can be applied to determine the identity of the player, such as by using facial identification software.

Matchmaking engine 110 determines whether the first player accepted the invite (decision block 306).

Responsive to determining that the first player did not accept the invite (“NO” branch, decision block 306), matchmaking engine 110 ends.

Responsive to determining that the first player did accept the invite (“YES” branch, decision block 306), matchmaking engine 110 places the first player in a competitive match (step 308).

As discussed above, matchmaking engine 110 can use any one or more methods of placing the first player in a competitive match. In some embodiments, the first player is limited to a competitive match solely between remote players. For example, an in-home electronic darts player can compete in a tournament limited to other in-home electronic darts players.

In another embodiment, a first player playing in a commercial location can be limited to competing with other players in other commercial locations. For example, matchmaking engine 110 can limit a first dart player in a darts club to competing against other darts players in other commercial locations.

In yet another embodiment, matchmaking engine 110 can allow players in commercial locations and in-home locations to compete against each other.

It is contemplated that matchmaking engine 110 is not limited the embodiments and examples described herein and can manage any mixture of players according to one or more matchmaking parameters.

Matchmaking engine 110 updates the performance data of the first player based on the outcome of the competitive match (step 310).

Matchmaking engine 110 offers the first player additional matches based the performance data of the first player (step 312).

In one embodiment, matchmaking engine 110 can offers the first player additional official competitions to compete in. For example, matchmaking engine 110 can offer the first player a spot at a national competition based on their player's statistics rising above a minimum threshold. In another example, matchmaking engine 110 can offer the first player additional local matches based on other amateur players at a similar skill level.

In alternative embodiments, matchmaking engine 110 can offer promotional material. For example, matchmaking engine 110 can provide the first player with a list of upcoming local competitions for dart players. In another example, matchmaking engine 110 can assist in connecting local electronic dartboard operators with in-home players by relaying relevant coupons and promotions to encourage in-home players to compete in public venues. As used herein, public venues can comprise any location that serves as a shared space, including, for example, clubs, bars, rented venues, and public spaces.

In addition to matchmaking functionality, matchmaking engine 110 can organize and execute head-to-head matches between local players, remote matches between remote players, and matches between commercial locations and remote players.

Further, matchmaking engine 110 can facilitate additional functionality beyond purely matchmaking. In one embodiment, matchmaking engine 110 can facilitate communication between one or more players. For example, a dart player can play as a group at the same time and in the same session. During the session, each player of the group can post scores, observe the play of other dart players through one or more sensors (e.g., cameras, microphones, pressure sensors, and etc.), and provide feedback. In another example, a dart player can be remotely coached by another player.

Matchmaking engine 110 can manage a social network. For example, matchmaking engine 110 can allow dart players to add friends, stream competitive matches, subscribe to streamers, remove friends, message other players, search for player profiles, and any execute any other social functionality.

Additionally, matchmaking engine 110 can manage teams. For example, matchmaking engine 110 can have team-based communications modules and added functionality for professional and amateur teams. Team-based communications modules can provide added utility, such as by providing team-only communications, team-specific visual elements, and team-specific audio elements.

Matchmaking engine 110 can also offer added functionality on an ongoing basis. For example, matchmaking engine 110 can be updated to handle new competitive modes and accommodate new technologies in the field as they arise. In a more specific example, matchmaking engine 110 can make additional free or purchasable game modes available to users. In another more specific example, matchmaking engine 110 can be updated with better software technologies and/or configured to work with new sensor technologies to improve the user experience.

In some embodiments, matchmaking engine 110 is user-customizable. For example, matchmaking engine 110 can receive specific matchmaking parameters by a group of players that require latency to stay beneath a maximum threshold to minimize risk of system lag. In another example, matchmaking engine 110 can receive parameters requiring each player in a group of players to participate in a specific tournament format. In yet another example, matchmaking engine 110 can receive parameters limiting match spectators to a pre-approved list of users. In yet another example, matchmaking engine 110 can receive parameters preventing players who quit intentionally from rejoining a game for a predetermined amount of time.

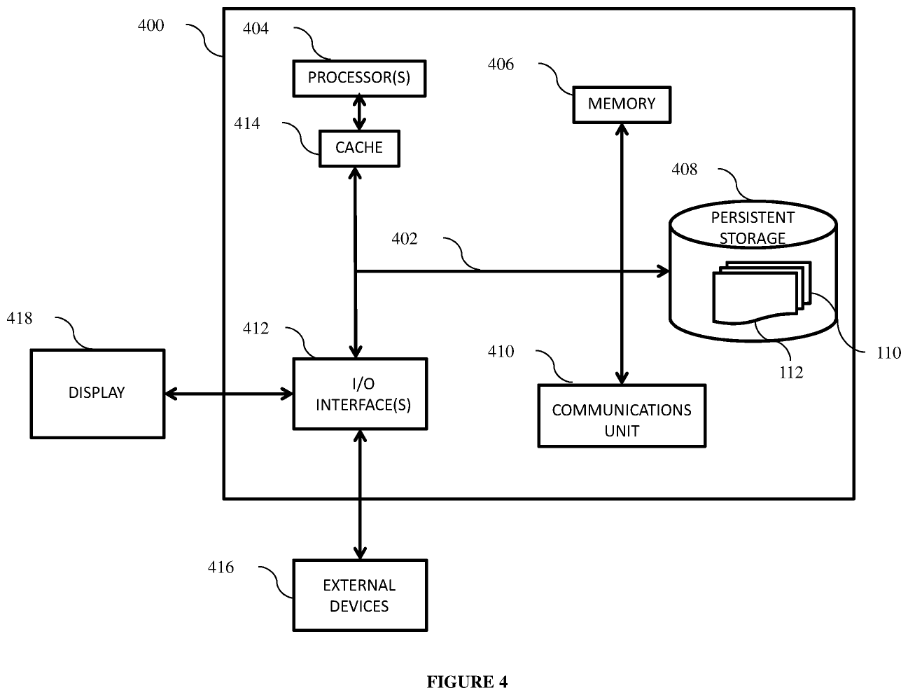

FIG. 4 depicts a block diagram of components of the server computer executing matchmaking engine 110 within the distributed data processing environment of FIG. 1.

FIG. 4 is not limited to the depicted embodiment. Any modification known in the art can be made to the depicted embodiment.

In one embodiment, the computer includes processor(s) 404, cache 414, memory 406, persistent storage 408, communications unit 410, input/output (I/O) interface(s) 412, and communications fabric 402.

Communications fabric 402 provides a communication medium between cache 414, memory 406, persistent storage 408, communications unit 410, and I/O interface 412. Communications fabric 402 can include any means of moving data and/or control information between computer processors, system memory, peripheral devices, and any other hardware components.

Memory 406 and persistent storage 408 are computer readable storage media. As depicted, memory 406 can include any volatile or non-volatile computer storage media. For example, volatile memory can include dynamic random access memory and/or static random access memory. In another example, non-volatile memory can include hard disk drives, solid state drives, semiconductor storage devices, a read-only memory (ROM), an erasable programmable read-only memory (EPROM), a flash memory, and any other storage medium that does not require a constant source of power to retain data.

In one embodiment, memory 406 and persistent storage 408 are random access memory and a hard drive hardwired to computing device 104, respectively. For example, computing device 104 can be a computer executing the program instructions of matchmaking engine 110 communicatively coupled to a solid state drive and DRAM.

In some embodiments, persistent storage 408 is removable. For example, persistent storage 408 can be a thumb drive or a card with embedded integrated circuits.

Communications unit 410 provides a medium for communicating with other data processing systems or devices, including data resources used by computing device 104. For example, communications unit 410 can comprise multiple network interface cards. In another example, communications unit 410 can comprise physical and/or wireless communication links.

It is contemplated that matchmaking engine 110, database 112, and any other programs can be downloaded to persistent storage 408 using communications unit 410.

In a preferred embodiment, communications unit 410 comprises a global positioning satellite (GPS) device, a cellular data network communications device, and short to intermediate distance communications device (e.g., Bluetooth®, near-field communications, etc.). It is contemplated that communications unit 410 allows computing device 104 to communicate with other computing devices 104 associated with other users.

Display 418 is contemplated to provide a mechanism to display information from matchmaking engine 110 through computing device 104. In preferred embodiments, display 418 can have additional functionalities. For example, display 418 can be a pressure-based touch screen or a capacitive touch screen.

In yet other embodiments, display 418 can be any combination of sensory output devices, such as, for example, a speaker that communicates information to a user and/or a vibration/haptic feedback mechanism. For example, display 418 can be a combination of a touchscreen in the dashboard of a car, a voice command-based communication system, and a vibrating bracelet worn by a user to communicate information through a series of vibrations.

Sensory input devices can also be used to supplement functionalities in matchmaking engine 110. For example, wireless communication means can be tied into matchmaking methods to automatically contact players for a match within a predetermined threshold of a first player. In another example, accelerometers and optical measurement devices can be used to track the movement of players to ensure compliance with official tournament rules. In a more specific example, accelerometers and optical measurements can provide data allowing matchmaking engine 110 to determine whether a player commits a foot fault.

Optical sensors and ranging sensors can be used to track player data. For example, LIDAR sensors can be used to track the trajectory and ultimate destination of a dart. Using this information, matchmaking engine 110 can overlay visual elements, such as an augmented reality element displaying the speed of the dart and a three-dimensional representation of the dart's path through the air. In another example, matchmaking engine 110 can overlay a score. In yet another example, matchmaking engine 110 can detect inconsistencies in the data to detect violations of tournament rules, such as determining, based on accelerometer data and LIDAR data, that a dart is likely above a 50-gram weight threshold.

It is contemplated that display 418 does not need to be physically hardwired components and can, instead, be a collection of different devices that cooperatively communicate information to a user.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. The characteristics are as follows: on-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a high level of abstraction (e.g., country, state, or data center). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of selected networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of recruiting remote players for a competitive event, comprising:
identifying a potential player;
retrieving skill metrics of the potential player;
determining whether the skill metrics of the potential player rises above a corresponding minimum skill threshold for the competitive event; and
responsive to determining that at least one of the skill metrics of potential player rises above the minimum skill threshold for the competitive event, sending the potential player an invitation to the competitive event.

2. The method of claim 1, wherein the competitive event is an in-person competition.

3. The method of claim 1, wherein the competitive event is a remote play competition.

4. The method of claim 1, further comprising updating the skill metrics of the potential player with respect to the competitive event.

5. The method of claim 1, further comprising updating a matchmaking database with the skill metrics of the potential player, wherein the matchmaking database comprises a collection of skill metrics from multiple players.

6. The method of claim 5, further comprising updating a matchmaking algorithm based on changes to the matchmaking database.

7. The method of claim 1, further comprising sending the potential player promotional material with respect to the event.

8. The method of claim 7, wherein the promotional material is at least one of a coupon, an invitation, and informational material.

9. The method of claim 1, wherein the skill metrics are specific to a type of event.

10. The method of claim 1, wherein the skill metrics are associated with multiple types of events.

11. The method of claim 1, wherein the event comprises playing at least one of a board game, a video game, and a physical sport.

12. The method of claim 1, wherein the potential player had previously signed up for a similar event.

13. The method of claim 1, wherein the potential player had not previously signed up for a similar event.

14. The method of claim 1, wherein the potential player has never participated in a similar event.

15. The method of claim 1, wherein the potential player had previously signed up for the event.

16. The method of claim 1, wherein the potential player had not previously signed up for the event.
